(19) United States
(12) Patent Application Publication
(10) Pub. No.: US 2021/0024313 A1
(43) Pub. Date: Jan. 28, 2021

(54) SENSOR CLEANING FOR PAPER FEEDING SYSTEM OF IMAGE FORMING APPARATUS

(71) Applicant: HEWLETT-PACKARD DEVELOPMENT COMPANY, L.P., Spring, TX (US)

(72) Inventors: Byung Hee CHO, Pangyo (KR); Jin Ho PARK, Pangyo (KR)

(73) Assignee: HEWLETT-PACKARD DEVELOPMENT COMPANY, L.P., Spring, TX (US)

(21) Appl. No.: 17/044,236

(22) PCT Filed: Apr. 4, 2019
(86) PCT No.: PCT/US2019/025838

§ 371 Date: Sep. 30, 2020

(30) Foreign Application Priority Data
Apr. 25, 2018 (KR) 10-2018-0048042

(51) Int. Cl. B65H 7/20; B65H 5/06; B65H 7/14; G03G 21/00; G03G 15/00

(52) U.S. Cl. CPC B65H 7/20; B65H 5/06; B65H 2515/842; G03G 21/0005; G03G 15/6529; B65H 7/14

(57) ABSTRACT

An image forming apparatus includes a printing engine to form an image on a printing medium, and a printing medium feeding device to supply the printing medium to the printing engine using a roller rotating in a feeding direction, and the printing medium feeding device includes a sensor to sense printing medium, and a cleaner to be driven by a reverse rotational force of the roller in a reverse direction to the feeding direction, to clean the sensing portion surface of the sensor.

### BACKGROUND

An image forming apparatus is an apparatus for generating, printing, receiving, and transmitting image data. Examples thereof include a printer, a copier, a facsimile, and a multifunctional apparatus integrally incorporating these functions.

A paper feeding device of the image forming apparatus includes a roller. Such a paper feeding device controls paper feeding using a value sensed by the sensor.

### BRIEF DESCRIPTION OF THE DRAWINGS

FIG. 1 is a block diagram illustrating brief configuration of an image forming apparatus according to an example;

FIG. 2 is a diagram illustrating brief configuration of an image forming apparatus of FIG. 1 according to an example;

FIG. 3 is a perspective view illustrating a roller and a cleaner of a paper feeding device according to an example;

FIG. 4 is a sectional view which cuts along IV-IV of FIG. 3;

FIG. 5 is an exploded perspective view of the paper feeding device of FIG. 3;

FIG. 6 is an exploded perspective view of a cleaner according to an example;

FIG. 7 is an enlarged view of VI of FIG. 3;

FIG. 8 is a sectional view illustrating a case where a cleaner is in an initial position or a standby position according to an example; and

FIG. 9 is a sectional view illustrating a case where a cleaner is in an operating position according to an example.

### DETAILED DESCRIPTION

Examples of the present disclosure will now be described in greater detail with reference to the accompanying drawings.

In the following description, same drawing reference numerals are used for the same elements even in different drawings. The matters defined in the description, such as detailed construction and elements, are provided to assist in a comprehensive understanding of the present disclosure. Accordingly, examples of the present disclosure can be carried out without those specifically defined matters.

Meanwhile, when the specification states that one constituent element is “connected to” another constituent element, it includes a case in which the two constituent elements are ‘connected to each other with another constituent element intervened therebetween’ as well as a case in which the two constituent elements are ‘directly connected to each other.’ Further, when one constituent element “comprises (or includes)” another constituent element, unless specifically stated to the contrary, it refers to that another constituent elements may be further included rather than precluding the same.

The expression “image forming job” as used herein may refer to various jobs related with image, such as, formation of image or generation/storage/transmission of image files (e.g., printing, scanning or faxing), and the expression “job” as used herein may refer to not only the image forming job, but also a series of processes for performance of the image forming job.

Further, the expression ‘image forming apparatus’ as used herein may refer to an apparatus that scans an image of the document and generates scanned image. Examples of the image forming apparatus may include a scanner, a copy machine, a facsimile, or a multi-function printer (MFP) implementing functions of the above. Meanwhile, when the image forming apparatus is a copy machine, a facsimile, a multi-function printer or the like, which are capable of the image forming job, the image forming apparatus may also be referred to as the image forming apparatus.

Further, the expression “image forming apparatus” as used herein refers to an apparatus that prints the printing data generated at a terminal such as a computer onto a recording medium. Examples of the image forming apparatus may include a copy machine, a printer, a facsimile, or a multi-function printer (MFP) implementing functions of the above. The printer, the scanner, the fax machine, the multi-function printer (MFP), a display apparatus or the like may represent any apparatus that can perform the image forming job.

Further, the expression “hard copy” as used herein may refer to an operation of outputting image on a recording medium such as paper, and the expression “soft copy as used herein may refer to an operation of outputting image on a display device such as a TV, a monitor or the like.

Further, the expression “content” as used herein may refer to any type of data as a subject of the image forming job, such as picture, image, document file or the like.

Further, the expression “printing data” as used herein may refer to data converted into format that can be printed at the printer. Meanwhile, when the printer supports direct printing, the file itself may be the printing data.

Further, the expression “user” as used herein may refer to a person who performs manipulation related with the image forming job using the image forming apparatus or a device connected to the image forming apparatus wiry or wirelessly. Further, the expression “manager” as used herein may refer to a person who has an authority to access all the functions and systems of the image forming apparatus. The “manager” and the “user” may refer to the same person.

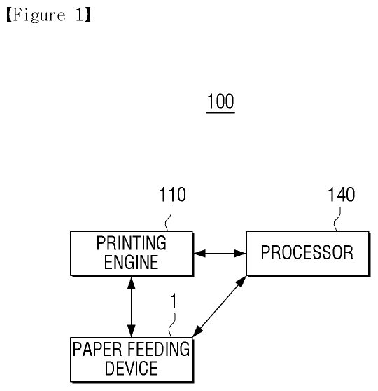

FIG. 1 is a block diagram illustrating brief configuration of an image forming apparatus according to an example.

Referring to FIG. 1, the image forming apparatus includes a printing engine 110, a paper feeding device 1, and a processor 140.

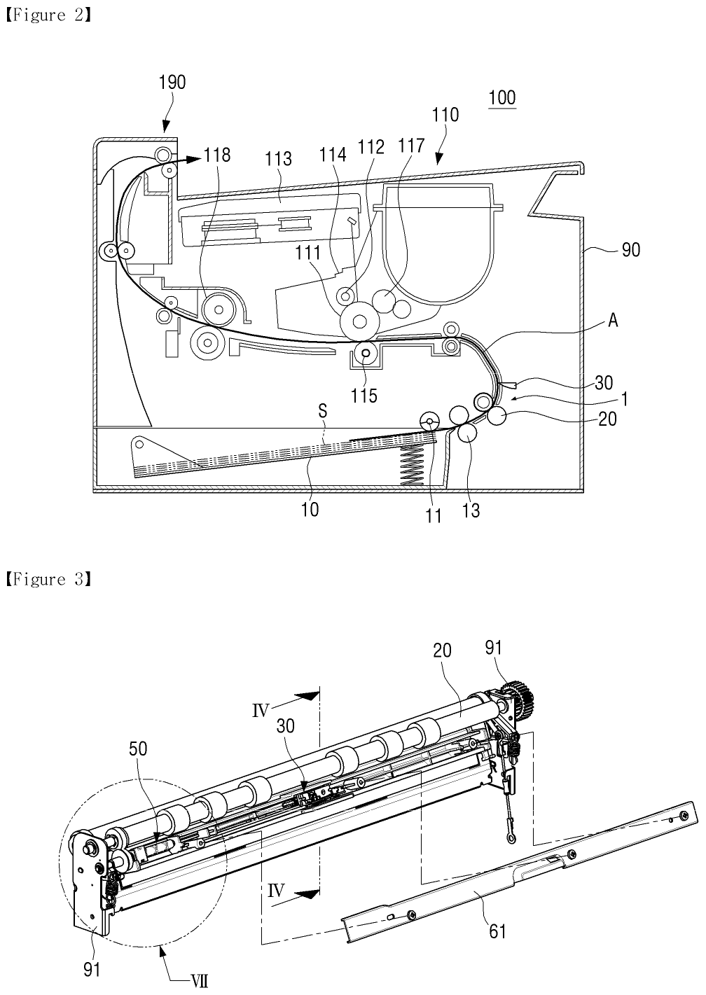

The printing engine 110 performs an image forming operation. Specifically, the printing engine 110 can perform an image forming operation by forming an image on an image forming medium and transferring the formed image to printing paper. The specific configuration and operation of the printing engine 110 will be described later with reference to FIG. 2.

The paper feeding device 1 moves the loaded paper to a feeding path. Specifically, the paper feeding device 1 picks up the printing paper loaded in the cassette 10 (see FIG. 2) so that the printing paper is supplied to the printing engine 110, and can transfer the picked-up printing paper to the feeding path. For this, the paper feeding device 1 may include at least one driving source and a plurality of rollers, a sensor 30 (see FIG. 2) for detecting paper, and a cleaner 50 (see FIG. 3) for cleaning the sensor 30, and so on. The specific configuration and operation of the paper feeding device 1 will be described later with reference to FIG. 3.

The processor 140 performs control for each configuration in the image forming apparatus 100. Specifically, when receiving the print data from the print control terminal device, the processor 140 may control the printing engine 110 so that the received print data is printed, and control the paper feeding device 1 to provide the printing paper to the printing engine 110.

The processor 140 may control the paper feeding device 1 so that the cleaner 50 cleans the sensor 30 when a predetermined event occurs. Specifically, the processor 140 may control the roller 20 to allow the cleaner 50 to clean the sensor 30. Here, the predetermined event may be an event which occurs when a user's sensor cleaning instruction is input, a specific event (for example, performing registration and replacing consumables, etc.) in the image forming apparatus occurs, or a result to determine whether to perform cleaning operations which will be described later is generated.

The processor 140 may determine whether to perform a cleaning operation based on at least one of information on the number of printing paper and an output value of the sensor 30 in the image forming apparatus 100.

For example, the processor 140 may control the cleaner 50 to clean the sensor 30 when cleaning is input by a user or for each predetermined frequency such as “once a day” or a predetermined printing amount such as “for 100 printing papers”.

The processor 140 may also determine whether the light received by the sensor 30 is less than or equal to a predetermined reference received light amount. If the received light is within a predetermined reference received light amount range, it can be determined that the sensor 30 is not contaminated. Conversely, when the received light is not within the reference received light amount range, the processor 140 can determine that the sensor 30 is contaminated and can control the cleaner 50 to clean the sensor 30.

The processor 140, when the number of determining that the sensor 30 is contaminated is greater than or equal to a predetermined threshold number, may control that the cleaner 50 cleans the sensor 30.

The sensor 30 can detect the paper and also may detect the presence of an object at a predetermined position. The sensor 30 can detect the cleaner 50 that cleans the sensor 30 on the paper feeding path A when the cleaner 50 cleans the sensor 30. Since a brush 59 of the cleaner 50 described later can be positioned at a predetermined position that is sensed for cleaning of the sensor 30, moving time information of the cleaner 50 can be confirmed by the sensor 30.

The processor 140 may check the moving time information of the cleaner 50 based on an output signal that detects the cleaner 50 which is output from the sensor 30, and control the roller 20 based on the checked moving time information.

More specifically, the processor 140 may control the cleaner 50 so that the brush 59 of the cleaner 50 reciprocates in a main scanning direction, and confirm time which is needed for a reciprocating movement or a one-way movement based on the signal value sensed by the sensor 30. Then, the processor 140 can control the operation of the cleaner 50 based on the confirmed time.

For example, if the time taken from when the sensor 30 detects the brush 59 of the cleaner 50 to redetect the brush is ten seconds, the moving time from the operating position of the brush 59 which is sensed by the sensor 30 to the operating position again seems ten seconds. Accordingly, the processor 140 can stop the reverse rotation of the roller 20 after five seconds have elapsed from when the brush 59 is sensed at the operating position to send the cleaner 50 back to the initial position after the cleaning operation. Accordingly, the brush 59 of the cleaner 50 can be moved to the initial position out of the paper feeding path A.

According to an example, when the sensor 30 is contaminated, the image forming apparatus 100 may manage the cleaner 50 for cleaning the contaminated sensor.

While a simple configuration of the image forming apparatus 100 has been shown and described above, various configurations may be additionally provided at the time of implementation. For example, a display for displaying a menu, a manipulation inputter for receiving a user manipulation, a memory for storing print data or internal data, and a communication device for performing communication with an external device can be further included. In addition, the image forming apparatus 100 may further include a scanner when a scanning operation is possible, and may further include a fax transmission/reception device when facsimile transmission/reception is possible.

FIG. 2 is a diagram illustrating brief configuration of an image forming apparatus of FIG. 1 according to an example. Hereinbelow, the image forming apparatus 100 including the paper feeding device according to an example will be described.

Referring to FIG. 2, the image forming apparatus 100 according to an example may be composed of a paper feeding device 1, a paper discharging part 190, and a processor 140.

The paper feeding device 1 is formed to receive a predetermined number of printing paper S, pick up printing paper S one by one, and provide the paper to the printing engine 110.

The printing engine 110 forms a predetermined image on the printing paper S supplied from the paper feeding device 1. The printing engine 110 may include a photoconductive drum 111, a charger 112, an exposure device 113, a developing device 114, a transfer device 115 and a fixing device 118. While the printing engine 110 and the paper feeding device 1 are shown as being different in configuration, the paper feeding device 1 may be a configuration within the printing engine 110.

An electrostatic latent image is formed on the photoconductive drum 111. Specifically, an image can be formed on the photoconductive drum 111 by an operation of the charger 112 and the exposure device 113, which will be described later. The photoconductive drum 111 may be referred to as an image forming medium, a photoconductive drum, a photosensitive belt, or the like depending on its form.

Hereinafter, the configuration of the printing engine 110 corresponding to one color will be described for convenient description, but in implementation, the printing engine 110 may include a plurality of photoconductive drums 111 corresponding to a plurality of colors, a plurality of chargers 112, a plurality of exposure devices 113, a plurality of developing devices 114, and an intermediate transfer belt.

The charger 112 charges the surface of the photoconductive drum 111 to a uniform potential. The charger 112 may be implemented in the form of a corona charger, a charging roller, a charging brush, or the like.

The exposure device 113 changes the surface potential of the photoconductive drum 111 according to the image information to be printed, thereby forming an electrostatic latent image on the surface of the photoconductive drum 111. As an example, the exposure device 113 can form a latent electrostatic image by irradiating the photoconductive drum 111 with light modulated in accordance with image information to be printed. The exposure device 113 of this type may be referred to as a light scanning device or the like, and an LED may be used as a light source.

The developing device 114 includes a developer therein, and supplies a developer (e.g., toner) to the electrostatic latent image to develop the electrostatic latent image into a visible image. The developing device 114 may include a developing roller 117 that supplies the developer to the electrostatic latent image. For example, the developer may be supplied from the developing roller 117 to the electrostatic latent image formed on the photoconductive drum 111 by a developing electric field formed between the developing roller 117 and the photoconductive drum 111.

The visible image formed on the photoconductive drum 111 is transferred to the printing paper by the transfer device 115 or the intermediate transfer belt (not shown). The transfer device 115 can transfer a visible image to the printing paper by, for example, an electrostatic transfer method. The visible image is attached to the printing paper by electrostatic attraction.

The fixing device 118 fixes the visible image to the printing paper by adding heat and/or pressure to the visible image on the printing paper. A printing operation is completed by the series of processes.

The paper feeding device 1 includes a pickup roller 11 for conveying the paper S, a plurality of conveying rollers 13 for conveying the paper S, the sensor 30 for sensing the paper S to be conveyed, a roller 20 for conveying the paper S and aligning the front end of the paper S and the processor 140 for controlling the paper feeding device 1 according to a signal from the sensor 30. The roller 20 may be a registration roller, and the sensor 30 may be a registration sensor.

When the pickup roller 11 rotates, the loaded paper S is conveyed to the printing engine 110. The pickup roller 11 rotates to pick up the paper S loaded on the cassette 10 and the picked up paper S is conveyed through the conveying roller 13. Thereafter, the paper S is sensed through the sensor 30, and the roller 20 is rotated at a predetermined timing to supply the paper S to the printing engine 110. The sensor 30 is installed on an upstream side of the roller 20 and senses the paper S. Such a sensor 30 may be a registration sensor.

The roller 20 is for controlling a position of an image. The roller temporarily stops the paper (S) before conveying the paper (S) to the printing engine 110 to align the leaning end of the paper (S) and match the leaning end of the paper to the front end of the image.

In the meantime, the paper feeding device 1 can perform the operation of rotating each configuration of the printing engine 110 described above. At the time of implementation, one paper feeding device 1 can simultaneously rotate a plurality of configurations of the printing engine 110, and a plurality of motors can be combined to rotate the plurality of configurations described above.

The paper feeding device 1 according to the present disclosure can also be applied to an ink jet printer. Therefore, although not shown, the printing engine 110 may be configured as an ink spray head that sprays predetermined ink according to print data.

The paper discharging part 190 discharges the printing paper on which a predetermined image is formed while passing through the printing engine 110, to the outside of the image forming apparatus 100. The paper discharging part 190 may be composed of a pair of paper discharge rollers.

A process of performing printing by the image forming apparatus is described as shown below.

First, when a printing instruction is received, the processor 140 controls the printing engine 110 to form an image on the photoconductive drum 111. A signal to supply the paper S is sent to the processor 140 so that the paper S can reach the transfer device 115 at the time when the image formed on the photoconductive drum 111 is conveyed to the transfer device 115. Then, the processor 140 drives the pickup roller 11 at a predetermined time to pick up the paper S. The picked-up paper S enters the roller 20. At this time, since the roller 20 is in the stopped state, the paper S cannot advance further, but is bent so as to form so-called curls. The processor 140 drives the roller 20 when a predetermined time elapses after the sensor 30 is turned on. Then, the paper S on which the curl has been formed is continuously conveyed to enter the printing engine 110, and the image is transferred to the paper S and fixed. The paper S on which image fixing has been completed is discharged to the outside of the image forming apparatus 100 through the paper discharging part 190.

The processor 140 can convey the paper S to the printing engine 110 through the roller 20.

The processor 140 turns on the pickup roller 11 and the paper S picked up by the pickup roller 11 is conveyed to the roller 20. The processor 140 then determines whether the sensor 30 is on. The sensor 30 transmits an on signal to the processor 140 when it senses the front end of the paper S. Then, the processor 140 turns on the roller 20 when the predetermined time has elapsed so that the roller 20 rotates.

Then, the paper S having curled at the front end of the roller 20 is conveyed to the printing engine 110, and the image is transferred to the paper S. At this time, since the processor 140 always drives the roller 20 after a lapse of a predetermined time after the pickup roller 11 is turned on, the paper S always reaches the printing engine 110 at a constant time. Thus, the image can always be transferred to a predetermined position of the paper S.

The sensor 30 senses the front end of the picked-up paper, thereby checking whether the pickup roller 11 normally picks up the paper, and aligns the position of the paper. When the paper S is detected through a sensor 30 provided on the upstream side of the roller 20, a clutch (not shown) is operated after a predetermined time and the power is transmitted to the shaft of the roller 20, and transferred to the printing engine 110.

When the surface of the sensing portion of the sensor 30 used for aligning the front end of the paper is contaminated with dust or waste toner, there is a possibility that the light transmitted or reflected may be erroneously detected, so that the surface of the sensing portion of the sensor 30 needs to be periodically cleaned. Accordingly, the image forming apparatus 100 according to an example includes the cleaner 50 (see FIG. 3) for cleaning the sensor 30.

The image forming apparatus according to an example cleans out a surface of the sensing portion of the sensor 30 using the cleaner 50 and thus, sensing error due to contamination of ink on the surface of the sensing portion does not occur.

In addition, when the surface of the sensing portion of the sensor is contaminated to cause a sensing error, the cleaner 50 can wipe the contaminated material (for example, toner, ink, and dust) on the surface of the sensing portion. Thus, there is no need to replace the whole sensor.

Thus, the present disclosure can be applied to the S path-type image forming apparatus and may also be applied to the C path-type image forming apparatus. In the illustrated example, it is described that one loading unit is provided. However, the image forming apparatus may be provided with a plurality of loading units, and the paper feeding device 1 may provide the printing paper of each loading unit to the printing engine 110.

Hereinafter, a specific structure of an image forming apparatus including a cleaner for cleaning a sensor according to an example will be described.

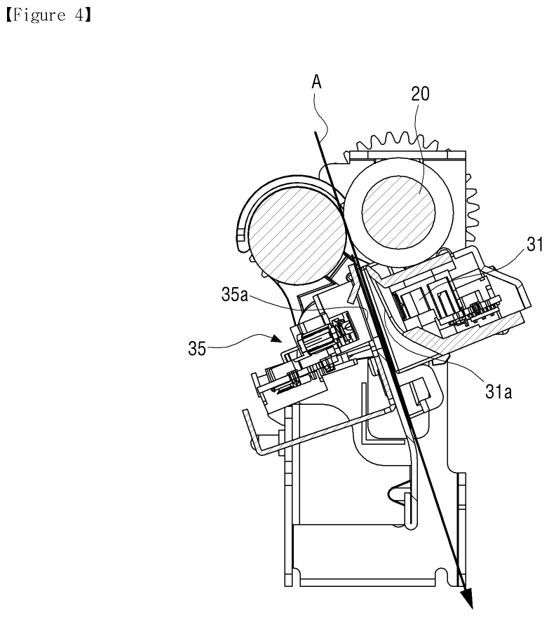

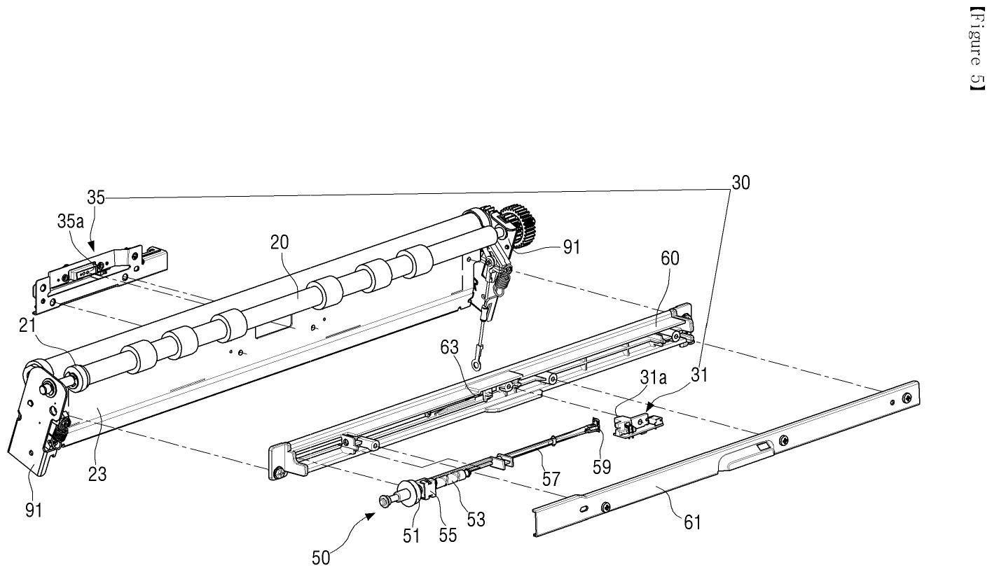

FIG. 3 is a perspective view illustrating a roller and a cleaner of a paper feeding device according to an example, FIG. 4 is a sectional view which cuts along IV-IV of FIG. 3, and FIG. 5 is an exploded perspective view of the paper feeding device of FIG. 3.

Referring to FIGS. 3, 4, and 5, the paper feeding device 1 according to an example includes the roller 20, the sensor 30 for sensing paper, and the cleaner 50 for cleaning the sensor 30.

The pair of rollers 20 is formed so as to be fixed to a frame of the paper feeding device 1 or an inner frame 91 of a main body 90 of the image forming apparatus. Between the pair of rollers 20, there can be provided a support frame 23 which forms the paper feeding path A and supports the paper S to be conveyed. The support frame 23 may be provided with a guide member 60 on which the cleaner 50 described later is mounted. There is provided the paper feeding path A through which the paper S is conveyed between the guide member 60 and the support frame 23. The pair of rollers 20 may be a registration roller which is disposed at the rear end of the registration sensor to feed the paper to the transfer unit.

The roller 20 includes a one-way clutch 21. The cleaner 50, which will be described later, may selectively receive rotational force through the one-way clutch 21 in response to the rotational direction of the roller 20, and rotates accordingly.

In the image forming apparatus 100 according to an example, the cleaner 50 can perform cleaning at a time other than the printing time. Accordingly, when the roller 20 rotates in the first direction in order to convey the paper in the paper conveying direction at the time of printing, the rotational force of the roller 20 is not transmitted to the cleaner 50, and when the roller 20 reversely rotates in the second direction, the rotational force can be transmitted to the cleaner 50 through the one-way clutch 21.

The paper S loaded on the cassette 10 is picked up by the pickup roller 11 and conveyed to the roller 20. The sensor 30 may be disposed upstream of the roller 20 in the paper conveying direction. At the time of implementation, the sensor 30 may be disposed downstream of the paper conveying direction.

The processor 140 can arrange paper by temporarily stopping the conveyance of the paper when the front end of the paper S arrives between the rollers 20 based on the sensing value of the sensor 30. When the clutch (not shown) is turned on, the paper S is moved in the paper feeding direction and the paper S is passed through the sensor 30. With the timing that the sensor 30 is turned on as the reference, the processor 140 may form an image.

The sensor 30 may be disposed at the upper end of the roller 20 to detect the printing paper S. The sensor 30 senses the returned signal after transmitting the infrared ray or the like in the direction of the paper feeding path A to determine whether or not the paper S exists at a predetermined position, and the characteristics of printing paper (for example, thickness of the paper S, gloss of the paper S, etc.).

The sensor 30 may be composed of a first portion 31 located on the upper side of the paper feeding path A and a second portion 35 located on the lower side of the paper feeding path A. The first portion 31 may be provided in the support frame 23. The second portion 35 may be provided in a guide member 60 to be described later. The sensor 30 may include a light emitting unit that emits light and a light receiving unit that receives light.

For example, a light emitting portion for irradiating light to the first portion 31 of the sensor 30 and a light receiving portion for receiving the irradiation light of the light emitting portion may be provided in the second portion 35. Light can be irradiated from a surface of the sensing portion surface 31a of the first portion 31 and light can be received from the sensing portion surface 35a of the second portion 35.

When the paper S interrupts the light from the light emitting portion of the sensor 30, the light receiving portion does not receive the light emitted from the light emitting portion, so that the front end of the paper which approaches the roller 20 is sensed. The sensor 30 generates a sensing signal of the paper front end and transmits the signal to the control IC.

The control IC receives the sensing signal of the front end of paper and recognizes the sensing point of the paper front end of the sensor 30 and transmits a driving control signal to the processor 140 so that the roller 20 is rotated after a predetermined time elapses from the sensing point.

Further, the control IC can discriminate types of paper based on the value sensed by the light receiving unit. In the present disclosure, it is described that the control IC discriminates the position of the paper and the paper type on the basis of the detection value of the light receiving unit. However, in the implementation, the sensor outputs various sensor values, and the determination of the type of paper may be performed by the processor 140.

In FIG. 4, the sensor 30 is described as being disposed on an upper side and a lower side with the paper feeding path A therebetween. However, the sensor 30 may include a light emitting portion for emitting light and a light receiving portion. The light emitting portion and the light receiving portion may be disposed on the upper side or the lower side of the paper feeding path A. That is, the sensor 30 may be formed on one side of the paper feeding path A.

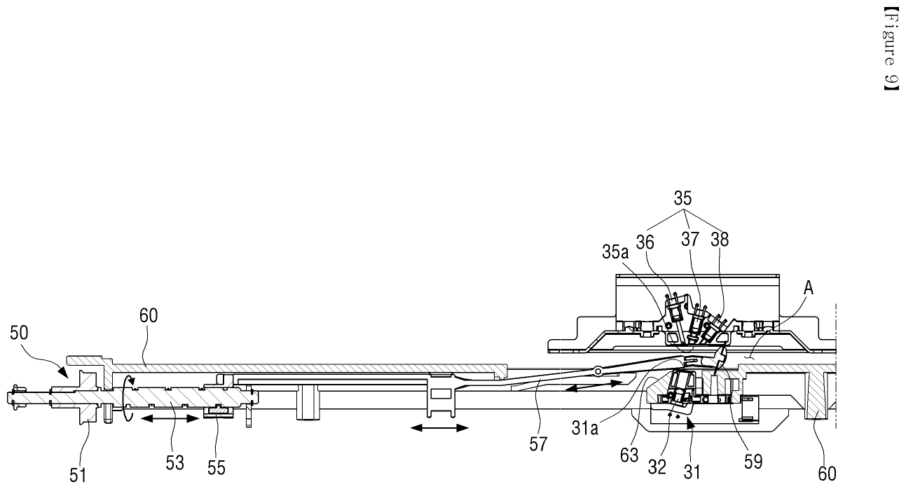

The sensor 30 may include a plurality of light receiving sensors 32, 37, and 38 (see FIG. 8) to identify types of the paper S which is fed. This will be described in greater detail in FIGS. 8 and 9.

The guide member 60 is fixed to the support frame 23, and the guide member 60 is spaced from the support frame 23 so that paper can pass therethrough.

The guide member 60 may be provided with the cleaner 50 and the second portion 35 of the sensor 30. The second portion 35 of the sensor 30 may be located at the center of the guide member 60, and the cleaner 50 may be located at one side of the second portion 35.

The guide member 60 on which the cleaner 50 and the sensor 30 are provided can be opened and closed by the cover 61.

Guide ribs 63 may be formed to be inclined toward the paper feeding path A where the sensor 30 is located. The cleaner 50 can move along the guide ribs 63 on the paper feeding path A where the sensor 30 is located and the cleaner 50 can move along the guide ribs 63 to outside of the paper feeding path A. That is, the cleaner 50 may be arranged to reciprocate between the first portion 31 and the second portion 35 of the sensor 30 along the guide ribs 63.

The cleaner 50 may be disposed to be parallel to the roller 20. The cleaner 50 can be formed to be reciprocally movable in the main scanning direction by the reverse rotation of the roller 20. The cleaner 50 can reciprocate in the main scanning direction to clean the sensing unit surfaces 31a and 35a of the sensor 30.

One end of the cleaner 50 is formed so as to be fixed to the frame of the paper feeding device 1 or the inner frame 91 of the main body 90 of the image forming apparatus. The cleaner 50 reciprocates in the main scanning direction within the guide member 60 and can enter the paper feeding path A along the guide ribs 63 of the guide member 60. The cleaner 50 is disposed outside the paper feeding path A when the image forming apparatus 100 is driven for printing and the cleaner 50 enters the paper feeding path A to clean the sensing portion surfaces 31a and 35a of the sensor 30.

Detailed cleaning operations of the cleaner 50 will be described in FIGS. 8 and 9.

The cleaner 50 may include an intermediate gear 51, a convey screw 53, a holder 55, a brush 59, and a link 57.

The sensor 30 senses the light transmitted or reflected from the paper S so that the first portion 31 and the second portion 35 of the sensor 30 respectively face the paper feeding path A. Therefore, the sensing surface portions 31a and 35a of the sensor 30 located in the paper feeding path A are exposed to a situation where foreign substances such as scattered toner are likely to be stacked. If the sensor 30 is contaminated with various contaminants, the paper S may not be smoothly sensed. In order to prevent such a situation in advance, the image forming apparatus 100 according to an example includes the cleaner 50.

The cleaner 50, in an initial position, is positioned at an outer side of the paper feeding path A, and moves on the paper feeding path A by the reverse rotation force of the roller 20 to remove the stacked contaminants in the surfaces 31a and 35a of the sensing portion of the sensor 30. The cleaner 50 can be constructed in a simple structure by operating the roller 20 in a reverse direction while the paper S is not moved without a separate driving device.

The cleaner 50 is attached to the guide member 60, and the guide member 60 in which the guide ribs 63 are provided can be fixed to the image forming apparatus 100.

The cleaner 50 may include the intermediate gear 51, the convey screw 53, the holder 55, the brush 59, and the link 57.

The intermediate gear 51 is installed in the cleaner 50 and can receive rotational force selectively via the one-way clutch 21 in accordance with the rotational direction of the roller 20. The intermediate gear 51 does not rotate when the roller 20 rotates in the first direction and can be rotated by the one-way clutch 21 when the roller 20 rotates in the second direction. When the intermediate gear 51 rotates, the convey screw 53 connected to the intermediate gear 51 can rotate together.

The convey screw 53 can be rotatably disposed by the rotation of the intermediate gear 51. The convey screw 53 may include a spiral convey groove 53a formed in an X-shape. The convey screw 53 can be formed such that the holder 55 coupled to the convey groove 53a changes its rotational direction and returns to its original starting position. The convey screw 53 need rotation in a single direction for reciprocating bidirectional lateral movement of the holder 55. The reciprocal bi-directional movement of the holder 55 can be performed by the convey groove 53a of the convey screw 53 and the convey projection 53b of the holder 55.

The holder 55 is mounted in the convey groove 53a of the convey screw 53 and can reciprocate in the main scan direction by the rotation of the convey screw 53. The link 57 may be connected to the holder 55.

At an end of the link 57, the brush 59 can be provided, and another end can be fixed to the holder 55. The brush 59 connected to the holder 55 through the link 57 can reciprocate in the main scanning direction in accordance with the reciprocating motion of the holder 55 in the main scanning direction.

The brush 59 is provided on the holder 55 and can clean the sensing portion surfaces 31a and 35a of the sensor 30 as the holder 55 reciprocates in the main scanning direction.

When the roller 20 rotates in the reverse direction, the intermediate gear 51 rotates together with the one-way clutch 21, and the convey screw 53 connected to the intermediate gear 51 rotates. The holder 55 and the brush 59 connected to the holder 55 are reciprocated in the main scanning direction by the rotation of the convey screw 53 so that contaminants stacked on the sensing surface portions 31a and 35a of the sensing portion of the sensor 30 can be removed.

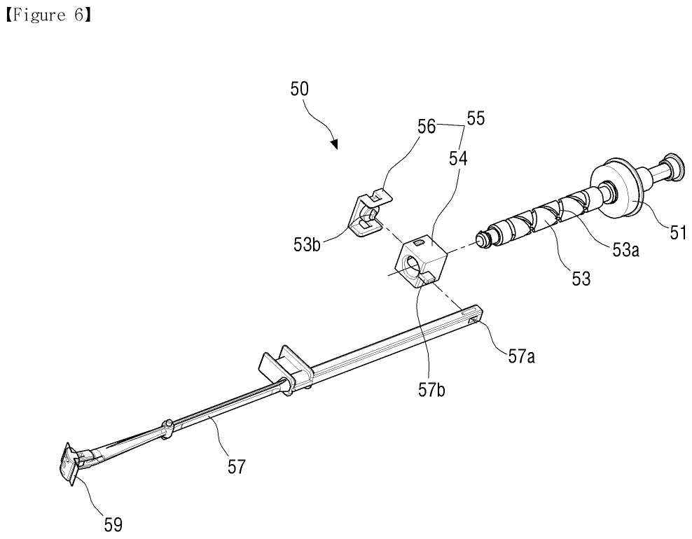

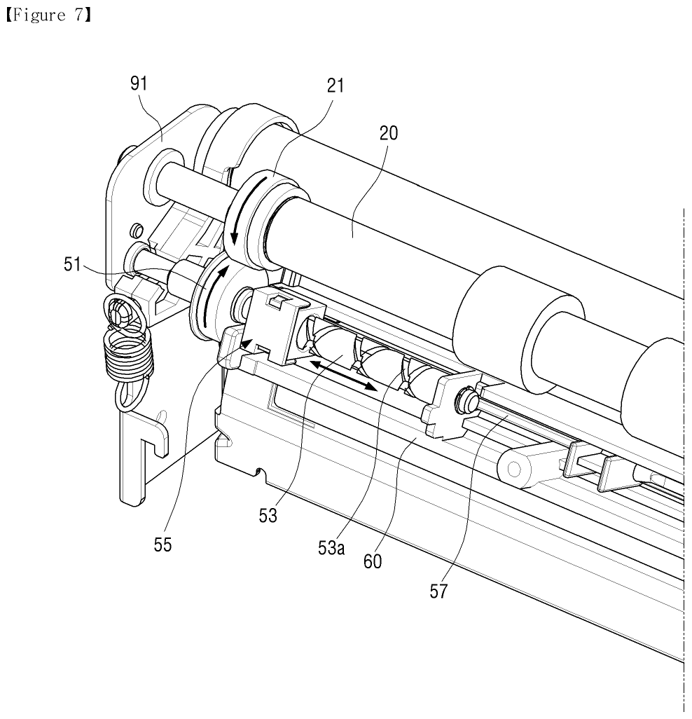

FIG. 6 is an exploded perspective view of a cleaner according to an example.

The coupling structure of the cleaner 50 will be described with reference to FIG. 6. The intermediate gear 51 can be coupled with the convey screw 53 so as to have the same rotation axis. The convey screw 53 can rotate together with the intermediate gear 51.

The holder 55 may be composed of the cap 56 including the body 54 inserted into the convey screw 53 and the convey projection 53b inserted into the convey groove 53a of the convey screw 53. The cap 56 is coupled to the body 54 and can be coupled so that the convey projection 53b of the cap 56 is seated in the convey groove 53a. The convey projection 53b seated in the convey grooves 53a can be reciprocated in the main scanning direction along the convey grooves 53a by the rotation of the convey screw 53.

At one side of the holder 55, a fixing protrusion 57b inserted into the fixing groove 57a formed in the link 57 is formed. The fixing protrusion 57b can be inserted and fixed into the fixing groove 57a. The link 57 connected to the holder 55 can also reciprocate in the main scanning direction by the reciprocating movement of the holder 55.

The holder 55 may be connected to one side of the link 57 and the brush 59 may be connected to the other side. The link 57 can be extensively formed to the side of the sensor 30. Accordingly, the brush 59 which has been moved in the main scanning direction by the link 57 is pushed in the direction of the sensor 30 along the guide ribs 63 of the guide member 60 and can continue to move along the paper feeding path A.

The link 57 and the brush 59 may be hinge-connected. The brush 59 can be coupled to the link 57 so as to be rotatable about the other end of the link 57. The brush 59 is hinge-connected to the link 57 so as to be rotatable at a predetermined angle so that the brush 59 is brought into close contact with the sensing surface portions 31a and 35a, when the sensing surface portions 31a and 35a of the sensor 30 are in contact with each other to remove foreign substances.

When the holder reciprocates by the force transmitted from the roller 20, the brush 59 moves to the paper feeding path A along the guide rib 63 or returns to initial position. In this case, the brush 59 can move in a reciprocal manner with respect to the link 57.

The brush 59 is connected to the holder 55 to clean the sensing portion surfaces 31a and 35a of the sensor 30 as the holder 55 reciprocates. The brush 59 may be formed so that one side is coupled to the link 57 and the other side is capable of contacting the sensing portion surfaces 31a and 35a of the sensor 30.

As the brush 59 passes between the first portion 31 and the second portion 35 of the sensor 30, the other side of the brush 59 can push the contaminants stacked on the sensing portion surfaces 31a and 35a to outside of the sensor 30. In a process where the brush 59 passes through the first portion 31 and the second portion 35 and then returns to the initial position again, the brush contacts the sensing portion surfaces 31a and 35a and thus, contaminants can be removed. The brush 59 is made of a fiber material that has been subjected to flocking treatment. Flocking refers to the process of spraying fine particles onto fabric. The brushes 59 subjected to the flocking treatment can remove contaminants more effectively by fine particles on the surface.

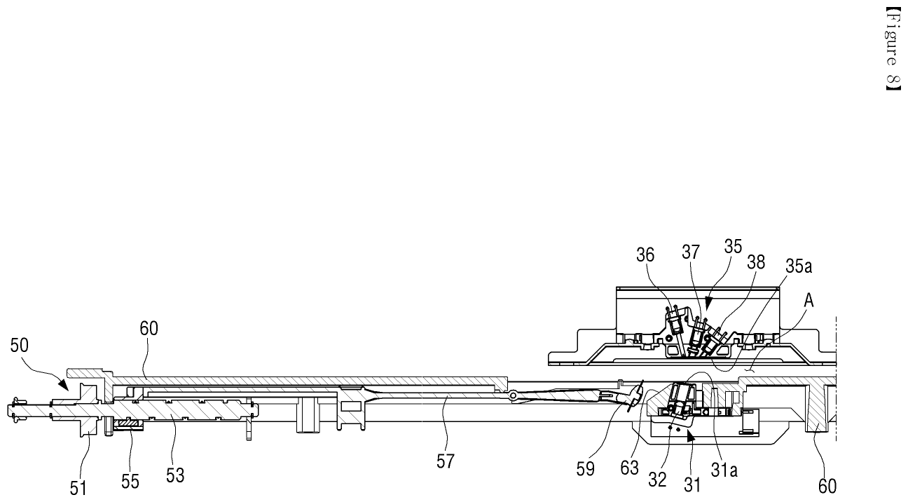

The operations of the image forming apparatus and the cleaner according to an example will be described with reference to FIGS. 7 to 9.

FIG. 7 is an enlarged view of Vlof FIG. 3.

Referring to FIG. 7, when the cleaner 50 is not driven and printing is performed, the sensor 30 may check whether paper S exists between the first portion 31 and the second portion 35 of the sensor 30, confirm whether the front end of the paper S is positioned at a predetermined position, and after a certain time is elapsed, the roller 20 rotates in the first direction to provide the paper S to the printing engine 110.

When the predetermined event occurs, the image forming apparatus 100 can perform cleaning. The roller 20 can be rotated in the second direction (the direction of the arrow shown in FIG. 7) so that the cleaner 50 can clean the sensor 30 during the cleaning operation. The one-way clutch 21 provided on the roller 20 transmits the rotational force to the intermediate gear 51 when the roller 20 rotates in the second direction, and the intermediate gear 51 receives the rotational force from the roller 20 to rotate. The convey screw 53 connected to the intermediate gear 51 can be rotated in association with the intermediate gear 51 in accordance with the rotation of the intermediate gear 51.

When the convey screw 53 is rotated in one direction, the holder 55 connected to the convey screw 53 can reciprocate along the main scanning direction. The link 57 and the brush 59 connected to the holder 55 by the reciprocating movement of the holder 55 can also reciprocate in the main scanning direction in cooperation with the holder 55.

FIG. 8 is a sectional view illustrating a case where a cleaner is in an initial position or a standby position according to an example, and FIG. 9 is a sectional view illustrating a case where a cleaner is in an operating position according to an example.

Referring to FIGS. 8 and 9, the sensor 30 according to an example will be described in more detail. The sensor 30 may be configured to detect the feature information such as presence or absence of paper, and thickness of paper and so on.

The image forming apparatus 100 may print image on a copying paper (hereinafter referred to as a paper) which is a generally used printing medium and may also print image on a photo paper, a transparent paper typified by an overhead project (OHP) film, and an inkjet paper coated with a printing surface to enhance ink adherence. Therefore, in order to print a clear image on various papers S, the printing method may be different according to the type of the paper S. To this end, the image forming apparatus 100 is provided with a sensor 30 to identify types of paper.

The sensor 30 can identify the type of paper by utilizing the fact that the light reflection characteristics are different from each other depending on the type of the paper. The sensor 30 may include a light emitting unit 36 that emits light in a predetermined direction, a light receiving unit that senses light incident in a predetermined direction, and a control IC that outputs the amount of the light sensed by the light receiving unit.

The light receiving unit may include a first light receiving sensor 32 for sensing light which is incident from a predetermined direction, a second light receiving sensor 37 which detects light amount which is irregularly reflected from the printing paper, and a third light receiving sensor 38 which senses light regularly reflected from printing paper.

The light emitting unit 36 includes the first light receiving sensor 32, the second light receiving sensor 37, and the third light receiving sensor 38. The light emitting unit 36, the second light receiving sensor 37 and the third light receiving sensor 38 are positioned on the upper side of the paper feeding path A and may correspond to the first portion 31 of the sensor 30. The light emitting unit 36, the second light receiving sensor 37 and the third light receiving sensor 38 are irradiated with light through the sensing portion surface 35a of the second portion 35.

The light emitting unit 36 irradiates light obliquely onto the printing surface of the paper S conveyed in a predetermined direction. The first light receiving sensor 32 may be provided at a position where the irradiated incident light can be sensed. The first light receiving sensor 32 can be positioned below the paper feeding path A opposite to the upper side of the paper feeding path A where the light emitting unit 36 is located.

The second light receiving sensor 37 may be provided at the center of the light emitting unit 36 and the third light receiving sensor 38 to sense irregularly-reflected light of the incident light. The third light receiving sensor 38 may be provided at a position capable of sensing positive reflected light reflected at the same reflection angle as the incident angle of the incident light.

The sensor 30 irradiates the light from the light emitting unit 36 and measures the size of the irregularly-reflected light of the print medium and the magnitude of the regularly-reflected light by the second light receiving sensor 37 and the third light receiving sensor 38, respectively. The type of the paper and the thickness of the paper can be identified using the ratio of the intensity of the regularly-reflected light and the intensity of the irregularly-reflected light.

In the illustrated example, three light receiving sensors are used. However, in the implementation, less than three light receiving sensors may be included, or four or more light receiving sensors may be used.

The image forming apparatus of the present disclosure and an operation of the cleaner are described below with reference to FIGS. 8 and 9.

Referring to FIG. 8, when the cleaner 50 of the image forming apparatus 100 is not operated, the holder 55 is positioned at one end of the convey screw 53, and the brush 59 is in a standby position at an initial position. The initial position means the position where the holder 55 is located at one end of the convey screw 53 closest to the intermediate gear 51 and the brush 59 is disposed outside the paper feeding path A.

The cleaner 50 can be positioned at an outer side of the paper feeding path A so as not to interfere with the paper S which is conveyed along the paper feeding path A.

Since the roller 20 rotates in the first direction, the cleaner 50 does not receive the rotational force of the roller 20 by the one-way clutch 21. As a result, the intermediate gear 51 and the convey screw 53 do not rotate, and the holder 55 does not move in the main scanning direction. The link 57 and the brush 59 connected to the holder 55 are located outside the paper feeding path A.

As for the sensor 30, the first portion 31 can be positioned in an upper side and the second portion 35 can be positioned at a lower side with the paper feeding path A therebetween. Therefore, various foreign substances can be stacked on the sensing surface portions 31a and 35a of the sensor 30.

In order to clean the sensing surface portions 31a and 35a of the sensor 30, if a predetermined event occurs, the cleaner 50 operates to clean the sensor 30.

Referring to FIG. 9, when the cleaner 50 of the image forming apparatus 100 is operated, the holder 55 can reciprocate along the lengthwise direction of the convey screw 53. When the holder 55 is reciprocated in the main scanning direction, the brush 59 moves between the first portion 31 and the second portion 35 of the sensor 30, and cleans the sensing portion surface 31a of the first portion 31 and the sensing portion surface 35a of the second portion 35.

The roller 20 rotates in the second direction and the one-way clutch 21 can transmit the reverse rotational force of the roller 20 to the intermediate gear 51. The intermediate gear 51 is rotated by receiving the rotational force of the roller 20 and can rotate the convey screw 53 together. When the convey screw 53 is rotated, the holder 55 screwed to the convey screw 53 can reciprocate in the main scanning direction. When the holder 55 reciprocates, the link 57 connected to the holder 55 can reciprocate in the main scanning direction. The connected brush 59 of the link 57 can be moved along the guide rib 63 to the paper feeding path A and moved to the operating position for cleaning the sensor 30.

The operating position means that the holder 55 is positioned at another end of the convey screw 53 which is the farthest from the intermediate gear 51, and the brush 59 is positioned at another side of the paper feeding path A.

As the brush 59 is moved to the operating position, the brush 59, which comes into contact with the sensing surface portions 31a and 35a of the sensor 30, can push the foreign substances which have been stacked on the sensing surface portions 31a and 35a to outside.

The brush 59 may reciprocate between the initial position and the operating position in association with the reverse direction rotation of the roller 20.

The roller 20 continues to rotate in the reverse direction so that the holder 55 can be positioned at one end of the convey screw 53, which is the initial position. The brush 59 is moved in a state in which the brush 59 is held in contact with the sensing surface portions 31a and 35a of the sensor 30 to remove foreign substances remaining in the sensor 30.

The foregoing examples are not to be construed as limiting examples. The present disclosure can be applied to other types of apparatuses. Also, the description of examples of the present disclosure is intended to be illustrative, and not to limit the scope of the claims.

What is claimed is:

1. An image forming apparatus, comprising:
a printing engine to form an image on a printing medium; and
a printing medium feeding device to supply the printing medium to the printing engine using a roller rotating in a feeding direction, the printing medium feeding device including:
a sensor having a sensing portion surface disposed to sense the printing medium; and
a cleaner to be driven by a reverse rotational force of the roller in a reverse direction to the feeding direction, to clean a sensing portion surface of the sensor.

2. The image forming apparatus of claim 1, wherein the cleaner reciprocates in a main scanning direction by the reverse rotational force of the roller.

3. The image forming apparatus of claim 1, wherein the cleaner comprises:
a brush to clean the sensing portion surface of the sensor;
a holder connected to the brush; and
a convey screw to reciprocate the holder using the reverse rotational force of the roller.

4. The image forming apparatus of claim 3, wherein the holder and the brush are linked by at least one link, and the brush is rotatably hinge-connected to a link among the at least one link at a predetermined angle.

5. The image forming apparatus of claim 3, further comprising:
a one-way clutch provided on the roller, the one-way clutch to selectively provide the reverse rotational force of the roller to the convey screw.

6. The image forming apparatus of claim 3, wherein
the holder reciprocates by the convey screw from an end of the convey screw to an opposite end of the convey screw opposite to the end, and
when the holder is positioned at the end of the convey screw, the brush is positioned at an outside of a medium feeding path along which the printing medium is to be conveyed, and
when the holder is positioned at the opposite end of the convey screw, the brush is positioned on the medium feeding path corresponding to a position of the sensor.

7. The image forming apparatus of claim 1, wherein the sensor is to
sense a disposition of the printing medium at a position on a medium feeding path along which the printing medium is to be conveyed, and
sense a property of the printing medium.

8. The image forming apparatus of claim 1, wherein the sensor comprises:
a light emitting unit to emit light in a first direction;
a light receiving unit to sense light incident in a second direction; and
a control IC to output a signal indicating a received amount of the light sensed by the light receiving unit.

9. The image forming apparatus of claim 8, wherein the light receiving unit comprises:
a first light receiving sensor to sense light regularly reflected from the printing medium;
a second light receiving sensor to sense light irregularly reflected from the printing medium; and
a third light receiving sensor to sense an amount of light which passes through the printing medium.

10. The image forming apparatus of claim 9,
wherein the first light receiving sensor, the second light receiving sensor, and the light emitting unit are positioned at a lower side under a medium feeding path along which the printing medium is to be conveyed,
wherein the third light receiving sensor is positioned at an upper side over the medium feeding path, and
wherein the cleaner cleans all of the upper side and the lower side.

11. The image forming apparatus of claim 1, comprising:
a processor to, in response to a preset event caused by the image forming apparatus occurring, control the roller, to control the cleaner to be driven to clean the sensing portion surface of the sensor.

12. The image forming apparatus of claim 11, wherein the processor is to
obtain moving time information of the cleaner based on an output signal of the sensor, and
control the roller based on the obtained moving time information.

13. The image forming apparatus of claim 11, wherein the processor is to determine whether to clean the sensing portion surface of the sensor based on at least one of
information on a number count of printing media, and/or
an output value of the sensor.

14. A printing medium feeding device to feed a printing medium, comprising:
a roller rotatable in a feeding direction to convey the printing medium;
a sensor to sense the printing medium; and
a cleaner supported by a frame to be driven by a reverse rotation of the roller in a reverse direction to the feeding direction, to clean a sensing portion surface of the sensor.

15. The printing medium feeding device of claim 14, wherein the cleaner comprises:
a brush to clean the sensing portion surface of the sensor;
at least one link where the brush is rotatably connected to a first end of the link;
a holder connected to a second end of the link being an opposite end opposite to the first end; and
a convey screw to reciprocate the holder using rotational force of the roller; and
a one-way clutch provided on the roller, the one-way clutch to selectively provide the rotational force of the roller to the convey screw.
